(19) United States
(12) Patent Application Publication
(10) Pub. No.: US 2025/0047152 A1
(43) Pub. Date: Feb. 6, 2025

(54) MOTOR COOLING SYSTEM

(71) Applicant: HYUNDAI MOBIS CO., LTD., Seoul (KR)

(72) Inventors: Yeong Woo SEO, Yongin-si (KR); Jong Jin PARK, Suwon-si (KR)

(73) Assignee: HYUNDAI MOBIS CO., LTD., Seoul (KR)

(21) Appl. No.: 18/643,064

(22) Filed: Apr. 23, 2024

(30) Foreign Application Priority Data
Aug. 4, 2023 (KR) 10-2023-0102040

(51) Int. Cl. H02K 1/20; H02K 1/18; H02K 5/20; H02K 5/22

(52) U.S. Cl. CPC H02K 1/20; H02K 1/18; H02K 5/20; H02K 5/225; H02K 2203/09

(57) ABSTRACT

The present disclosure relates to a system for cooling a stator core of an electric motor. The motor cooling system according to the present disclosure is advantageous in that the number of parts can be minimized, and cooling efficiency can be maximized with a cooling fluid evenly distributed to a heat-generating area, by improving a typical design (a core press-fit stop end) of a housing supporting the stator core to add a fluid guide and a nozzle shape or by applying a nozzle ring formed in a curved shape and capable of spraying the cooling fluid after being received and stored to an end of the housing.

### CROSS-REFERENCE TO RELATED APPLICATIONS

This application claims priority under 35 U.S.C. § 119 to Korean Patent Application No. 10-2023-0102040, filed on Aug. 4, 2023, in the Korean Intellectual Property Office, the disclosure of which is incorporated herein by reference in its entirety.

### TECHNICAL FIELD

The following disclosure relates to a system for cooling a stator core of an electric motor.

### BACKGROUND

Heat generated in an electric motor is mainly caused by losses occurring in a stator coil and an electrical steel sheet, and if the generated heat lasts in an uncooled state, this may lead to losses of parts applied to the motor. Therefore, it is preferable to maintain proper cooling using various fluids such as air, water, and oil (direct cooling) to stably operate the motor and extend the lifespan of the motor. In the conventional art, various parts and methods such as pipes, guides, nozzles, and churning have been used for cooling, and the fluidity of the cooling fluid has been improved to increase cooling efficiency.

However, in the conventional art, there has been a common problem that when a motor is directly cooled, a fluid may not be uniformly distributed to a heat-generating area. In particular, a heat generation rate is high in an end coil area, which has a significant impact on the motor parts if cooling is not locally performed. In order to induce local cooling, various methods have been used. However, in the pipe method, there has been a problem that the number of parts increases and the cost is high, and in the reflecting plate method, there has been a problem that cooling efficiency is poor.

### SUMMARY

An embodiment of the present disclosure is directed to providing a motor cooling system capable of minimizing the number of parts and maximizing cooling efficiency with a cooling fluid evenly distributed to a heat-generating area, by improving a typical design (a core press-fit stop end) of a housing supporting a stator core to add a fluid guide and a nozzle shape.

Another embodiment of the present disclosure is directed to providing a motor cooling system capable of maximizing cooling efficiency with a cooling fluid evenly distributed to a heat-generating area by applying a nozzle ring formed in a curved shape and capable of spraying the cooling fluid after being received and stored to an end of a housing.

In one general aspect, a motor cooling system includes: a cylindrical stator core with a coil wound to be fitted on an inner side thereof; a housing fitted on an outer side of the stator core to support a position of the stator core, and having an injection port formed therethrough to inject a cooling fluid; and a cooling fluid spraying part including a structure guiding the cooling fluid injected through the injection port and flowing between the stator core and the housing to flow toward the coil.

The stator core may include at least one first cooling passage that is a groove formed in an outer surface thereof in an axial direction, and the housing may include at least one second cooling passage that is a groove formed in an inner surface thereof in a circumferential direction.

The stator core may include two or more cooling lines, each including two or more first cooling passages formed adjacent to one another, and the cooling lines may be formed to be spaced apart from one another at predetermined intervals in the circumferential direction.

The cooling fluid spraying part may include a nozzle ring coupled to one end of the housing, and the nozzle ring may include a fixing portion coupled to one end of the inner surface of the housing; a fluid storage portion having one end integrally formed with the fixing portion and another end in contact with one end surface of the stator core; and a first fluid spraying hole formed through the fluid storage portion.

The cooling fluid spraying part may include a core support end formed at one end of the housing, and the core support end may include: a first support end extending from the inner surface of the housing in a radial direction; a second support end extending from a distal end of the first support end in the axial direction; and a second fluid spraying hole formed through at least one of the first support end or the second support end.

The motor cooling system may further include a terminal bus bar including a first coupling portion coupled to the housing and a second coupling portion coupled to the coil, and the cooling fluid spraying part may further include an extending support portion fitted between the stator core and the housing while covering an outer surface of the stator core, with one end thereof being coupled to the first coupling portion and the second coupling portion of the terminal bus bar.

The extending support portion may include: a cylindrical first extension extending to cover the outer surface of the stator core; and a second extension disposed between the first extension and the first and second coupling portions to cover and protect an area where the coil is provided, and the second extension may be formed to be concave inwardly from the first extension.

An inner surface of the first extension contacting the stator core may include a curved surface to match the outer surface of the stator core, and an outer surface of the first extension contacting the housing may be formed to be gradually inclined to the stator core toward a distal end of the first extension.

The housing may further include a fixing groove formed in an inner surface thereof to correspond to the inclined outer surface of the first extension.

The stator core may further include a support groove formed to be concave from the outer surface thereof and extending in a circumferential direction, and the first extension may include a protrusion protruding from an inner surface thereof to correspond to the support groove.

The motor cooling system having the configuration as described above is advantageous in that the number of parts can be minimized, and cooling efficiency can be maximized with a cooling fluid evenly distributed to a heat-generating area, by improving a typical design (a core press-fit stop end) of a housing supporting a stator core to add a fluid guide and a nozzle shape.

The motor cooling system having the configured as described above is also advantageous in that cooling efficiency can be maximized with a cooling fluid evenly distributed to a heat-generating area, by applying the nozzle ring formed in a curved shape and capable of spraying the cooling fluid after being received and stored to the end of the housing.

### BRIEF DESCRIPTION OF THE DRAWINGS

FIG. 1 is an axial cross-sectional view of a motor cooling system according to the present disclosure.

FIG. 2 is a radial cross-sectional view of a stator core according to the present disclosure.

FIG. 3 is a perspective view of the stator core according to the present disclosure.

FIG. 4 is a partial perspective view of a housing according to the present disclosure.

FIG. 5 is a perspective view of a nozzle ring according to the present disclosure.

FIG. 6 is a partial perspective view illustrating a coupling relationship between the nozzle ring, the housing, and the stator core according to the present disclosure.

FIG. 7 is a partial perspective view of the housing in which a core support end is formed according to the present disclosure.

FIG. 8 is an axial cross-sectional view of a motor cooling system to which an extending support is applied according to the present disclosure.

FIG. 9 is an axial cross-sectional view illustrating an embodiment of the extending support portion according to the present disclosure.

### DETAILED DESCRIPTION OF MAIN ELEMENTS

1000: Motor cooling system
100: Stator core
110: Cooling line
111: First cooling passage
120: Support groove
200: Housing
210: Injection port
220: Second cooling passage
230: Fixing groove
240: Ring coupling groove
300: Terminal bus bar
310: First coupling portion
320: Second coupling portion
400: Cooling fluid spraying part
410: Nozzle ring
411: Fixing portion
412: Fluid storage portion
413: First fluid spraying hole
420: Core support end
421: First support end
422: Second support end
423: Second fluid spraying hole
430: Extending support portion
431: First extension
432: Second extension
433: Protrusion
C: Coil

### DETAILED DESCRIPTION OF EMBODIMENTS

Hereinafter, the technical idea of the present disclosure will be described in more detail with reference to the accompanying drawings. Further, terms or words used in the specification and claims herein should not be interpreted as being limited to the ordinary or dictionary meanings, but interpreted as meanings and concepts corresponding to the technical idea of the present disclosure based on the principle that the inventor can appropriately define concepts of terms to describe his/her invention in the best way.

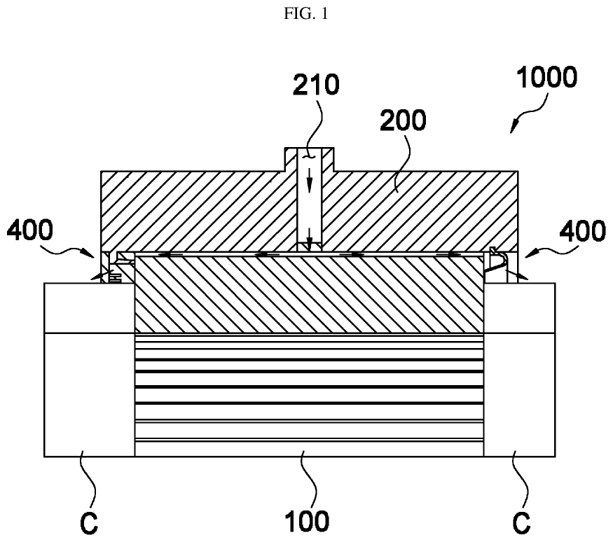

Hereinafter, a basic configuration of a motor cooling system 1000 according to the present disclosure will be described with reference to FIG. 1.

As illustrated in FIG. 1, the motor cooling system 1000 according to the present disclosure may include a cylindrical stator core 100 hollowed at the center with a coil C wound to be fitted on an inner side thereof, and a housing 200 fitted on an outer side of the stator core 100 to support a position of the stator core 100 and having an injection port 210 formed therethrough to inject a cooling fluid. More specifically, the stator core 100 may include a slot of a predetermined depth formed in a radial direction to communicate with the central hollow, and a plurality of slots may be formed to be spaced apart from one another at predetermined intervals in a circumferential direction. A strand of the coil C may be wound to be fitted into each slot.

In addition, the motor cooling system 1000 according to the present disclosure may include a terminal bus bar 300 (not illustrated in FIG. 1). The terminal bus bar 300 may be coupled to the housing 200 by bolting to form a first coupling portion 310, and coupled to the coil C by welding to form a second coupling portion 320. Accordingly, the position of the coil C may depend on the housing 200, and the housing 200 may be made of a conductive material to be electrically connected to the coil C.

In addition, the motor cooling system 1000 according to the present disclosure may include a cooling fluid spraying part 400. The cooling fluid spraying part 400 may include a processing shape (a protrusion or a groove) applied to the housing 200 or the terminal bus bar 300, or may include a part additionally attached to the housing 200 or the stator core 100. The specific configuration thereof will be described in the following paragraphs.

The cooling fluid spraying part 400 may spray the cooling fluid injected through the injection port 210 formed in the housing 200 to the coil C, more specifically, to the end coil C drawn toward the outside of the stator core 100. By including the cooling fluid spraying part 400, the cooling fluid can be brought into contact with the end coil C more efficiently, resulting in an increase in cooling efficiency.

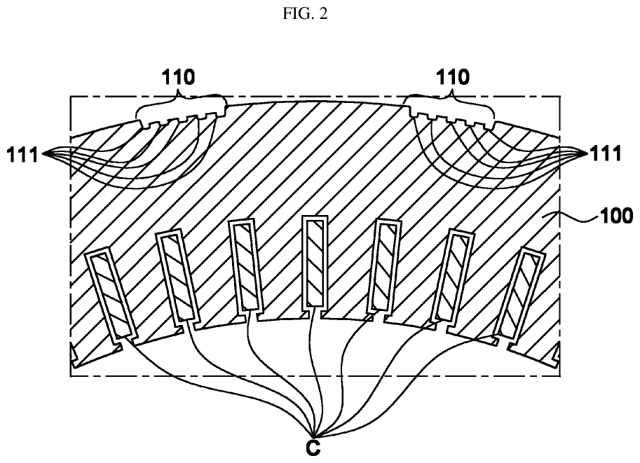

Hereinafter, a path along which a cooling fluid flows according to the present disclosure will be described in more detail with reference to FIGS. 2 to 4.

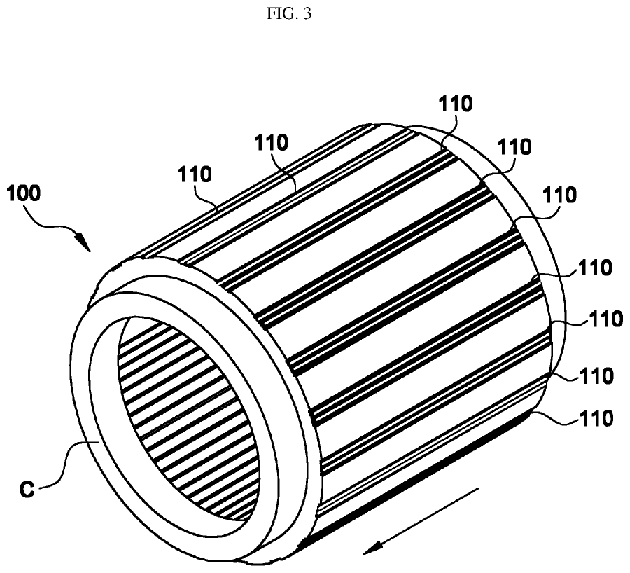

As illustrated in FIGS. 2 and 3, the stator core 100 may include at least one first cooling passage 111, which is a groove formed in an axial direction on an outer surface thereof. By including the first cooling passage 111, the cooling fluid introduced through the injection port 210 of the housing 200 can flow along a side surface of the stator core 100 to cool the stator core 100.

In this case, the stator core 100 may include two or more cooling lines 110 formed adjacent to one another, each of the cooling lines 110 including the first cooling passage 111. The two or more cooling lines 110 may be formed to be spaced apart from one another at predetermined intervals in the circumferential direction. In this case, a distance between the first cooling passages 111 spaced apart from one another in one cooling line 110 may be shorter than a distance between the cooling lines 110 spaced apart from one another. Accordingly, the first cooling passage 111 may serve as a guide protrusion so that the cooling fluid flows along the cooling line 110, that is, moves in the axial direction.

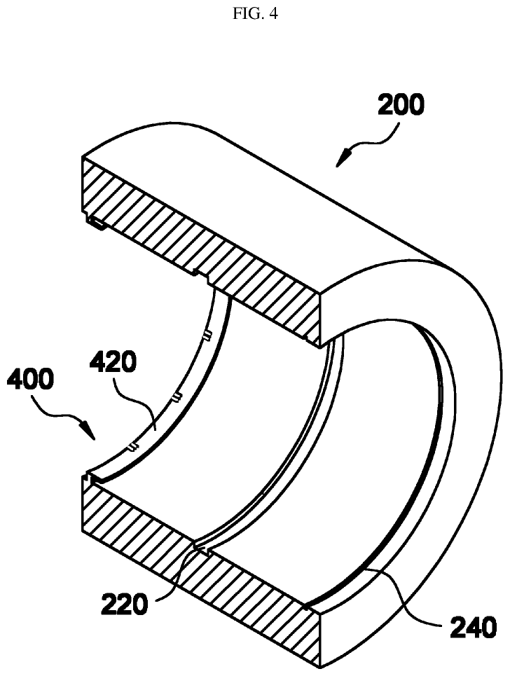

In addition, as illustrated in FIG. 4, the housing 200 may include at least one second cooling passage 220, which is a groove formed in an inner surface thereof along the circumferential direction. Two or more second cooling passages 220 may be formed, and the second cooling passages 220 may be formed to be spaced apart from one another in the axial direction. In addition, at least one of the second cooling passages 220 may directly communicate with the injection port 210. Accordingly, the cooling fluid can flow in the order of the injection port 210→one second cooling passage 220→the first cooling passage 111→another second cooling passage 220, thereby simultaneously cooling the entire side surface of the stator core 100, and furthermore, improving cooling efficiency.

Additionally, the housing may be formed in such a manner as to the cooling fluid spraying part or a partial configuration of the cooling fluid spraying part is coupled to each of both ends thereof. For example, a ring coupling groove 240 for inserting a nozzle ring 410, which is a first embodiment of the cooling fluid spraying part 400, may be formed at one end of the housing, or a core support end 420, which is a second embodiment of the cooling fluid spraying part 400, may be formed integrally at one end of the housing.

Each embodiment of the cooling fluid spraying part 400 will be described in detail in the following paragraphs.

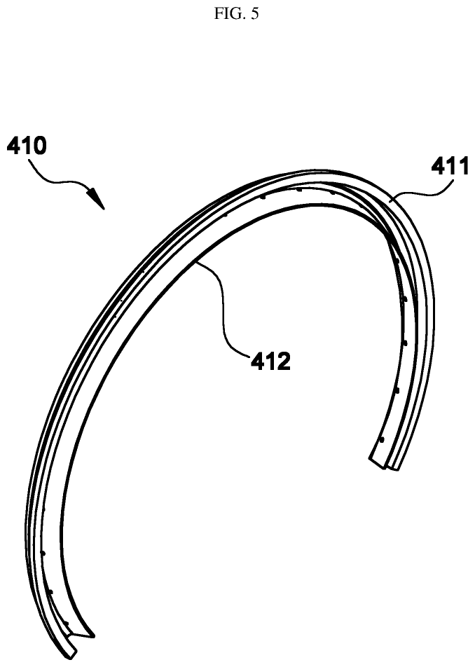

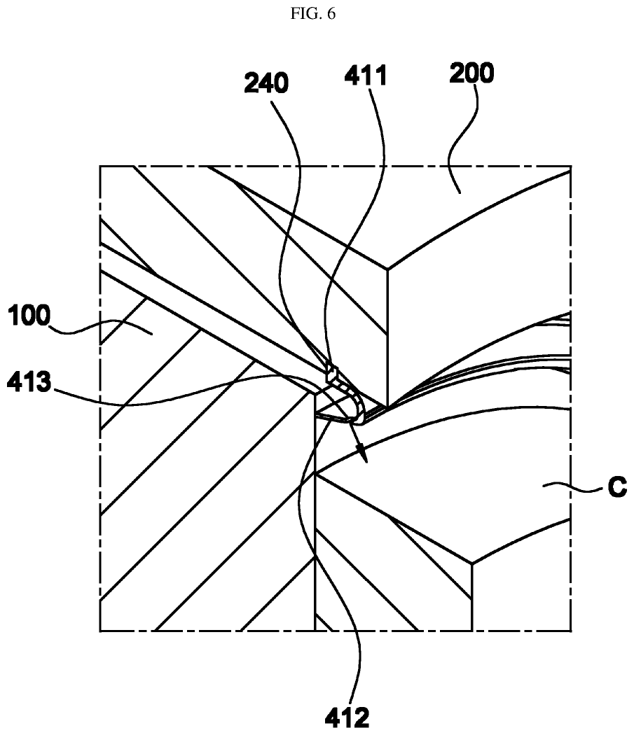

Hereinafter, the first embodiment of the cooling fluid spraying part 400 according to the present disclosure will be described in more detail with reference to FIGS. 5 and 6.

As illustrated in FIG. 5, the cooling fluid spraying part 400 may include a nozzle ring 410 coupled to one end of the housing 200. The nozzle ring 410 may be made of a material that is elastic and has an elastic force greater than or equal to a predetermined numerical value. For example, the nozzle ring 410 may be made of rubber or silicone. As illustrated in FIG. 6, the nozzle ring 410 may include a fixing portion 411 coupled to one end of an inner side surface of the housing 200. In addition, the nozzle ring 410 may include a fluid storage portion 412 of which one end is formed integrally with the fixing portion 411, and the other end is in contact with one end surface of the stator core 100. Additionally, the nozzle ring 410 may include a first fluid spraying hole 413 formed through the fluid storage portion 412.

More specifically, the fluid storage portion 412 may be formed to have a curved surface, and a partial portion of the fluid storage portion 412 may protrude toward the end coil C after being bent to form a question mark shape. Accordingly, the cooling fluid can stay in the fluid storage portion 412 for a predetermined period of time. In addition, the first fluid spraying hole 413, which is formed in the fluid storage portion 412, may be formed at a position protruding highest in the axial direction toward the end coil C with respect to the fixing portion 411, thereby spraying the cooling fluid toward the end coil C at a maximum flow rate and at a maximum flow pressure.

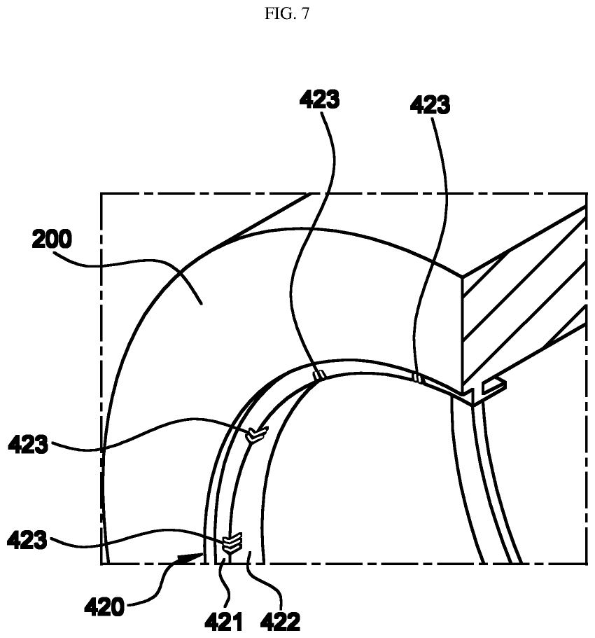

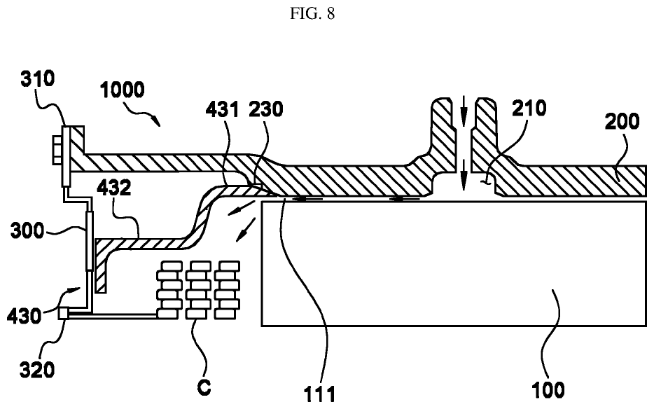

Hereinafter, the second embodiment of the cooling fluid spraying part 400 according to the present disclosure will be described in more detail with reference to FIGS. 7 and 8.

As illustrated in FIG. 7, the cooling fluid spraying part 400 may include a core support end 420 formed at one end of the housing 200. The core support end 420 preferably includes a first support end 421 extending in the radial direction from the inner side surface of the housing 200, a second support end 422 extending in the axial direction from a distal end of the first support end 421, and a second fluid spraying hole 423 formed through the first support end 421 or the second support end 422.

More specifically, the first support end 421 and the second support end 422 may be perpendicular to each other, and the first support end 421 and the second support end 422 may be formed integrally with the housing 200, and may be formed together at the time of injection-molding the housing 200. Additionally, the first support end 421 may have a larger thickness than the second support end 422. Accordingly, even if the cooling fluid flowing out between the housing 200 and the stator core 100 directly hits the first support end 421, the first support end 421 can be kept structurally stable over a long period of time with no damage.

In addition, the second fluid spraying hole 423 may be formed to penetrate through both the first support end 421 and the second support end 422. As an example, as illustrated in FIG. 7, the second fluid spraying hole 423 may be a “¬”-shaped hole formed through all of the first support end 421, the second support end 422, and an corner where the first support end 421 and the second support end 422 meet. Alternatively, the second fluid spraying hole 423 may be provided individually in each of the first support end 421 and the second support end 422. However, in this case, each second fluid spraying holes 423 may be formed close to the corner where the first support end 421 and the second support end 422 meet, that is, at a position where a distance from the corner is smaller than a predetermined reference value. Accordingly, the second fluid hole can be formed at a position protruding closest to the end coil C with respect to the first support end 421 and the second support end 422, thereby spraying the cooling fluid toward the end coil C at a maximum flow rate and at a maximum flow pressure.

At this time, the core support end 420 may be designed by modifying a compression prevention end provided in the typical design of the housing 200. By including the core support end 420, the motor cooling system 1000 according to the present disclosure is capable of not only spraying the cooling fluid but also preventing the stator core 100 from being pushed out of the housing 200. To this end, the distal end of the second support end 422 may be formed to contact the end of the stator core 100.

Hereinafter, a third embodiment of the cooling fluid spraying part 400 according to the present disclosure will be described with reference to FIG. 8.

As illustrated in FIG. 8, the cooling fluid spraying part 400 may include an extending support portion 430. The extending support portion 430 may be fitted between the stator core 100 and the housing 200 while covering the outer surface of the stator core 100, with one end thereof being coupled to the first coupling portion 310 and the second coupling portion 320 of the terminal bus bar 300. The extending support portion may include a cylindrical first extension 431 extending to cover the outer surface of the stator core 100, and a second extension 432 provided between the first extension 431 and the first and second coupling portions 310 and 320 to cover and protect an area where the coil C is provided.

By including the extending support portion 430, the cooling fluid sprayed from and flowing out of the first cooling passage 111 can be stored within the extending support portion 430 without leaking to the outside, thereby maximizing cooling efficiency. In this case, the second extension 432 may be formed to be concave inside the first extension part 431. Accordingly, the second extension 432 can be located closer to the end coil C, and the contact between the cooling fluid and the end coil C can be increased, resulting in an increase in cooling efficiency.

In addition, an inner surface of the first extension 431 contacting the stator core 100 may include a curved surface to match the outer surface of the stator core 100. In addition, an outer surface of the first extension 431 contacting the housing 200 may be formed to be gradually inclined to the stator core 100 toward a distal end of the first extension 431. That is, the first extension 431 may be formed to have a thickness that becomes smaller toward the distal end thereof. Accordingly, elasticity can be formed at the distal end of the first extension 431, and the adhesive force between the first extension 431 and the stator core 100 can be increased.

In addition, the housing 200 may further include a fixing groove 230 formed in the inner surface thereof to correspond to the distal end of the outer surface of the first extension 431. In this case, the fixing groove 230 may be formed in the form of an inclined surface or a step having the same slope as the distal end of the first extension 431. Accordingly, the housing 200 can press the first extension 431 on the outer surface of the first extension 431, and furthermore, fix the position of the extending support portion. Accordingly, even if vibrations occur continuously in the motor, structural stability can be ensured because the extending support portion 430, the stator core 100, and the housing 200 are not separated from each other.

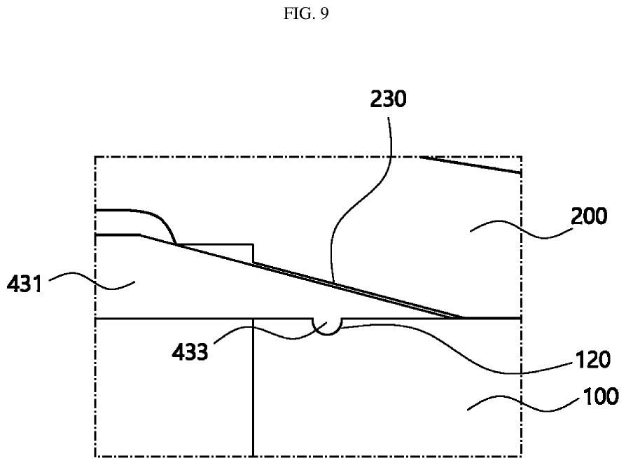

Furthermore, as illustrated in FIG. 9, the stator core 100 may further include a support groove 120 formed to be concave in the outer surface thereof in the circumferential direction, and the first extension 431 may include a protrusion 433 protruding from the inner surface thereof to correspond to the support groove 120. In this case, the protrusion 433 may be formed to correspond to the support groove 120, excluding an area where a cooling fluid flow passage is formed. Accordingly, the coupling between the first extension 431 and the stator core 100 can be supported more strongly, and further, the position of the extending support portion can be fixed. Ultimately, even if vibrations occur continuously in the motor, structural stability can be ensured because the extending support portion 430, the stator core 100, and the housing 200 are not separated from each other.

The technical idea should not be interpreted as being limited to the above-described embodiments of the present disclosure. The present disclosure is applicable in a variety of ranges, and may be modified in various manners by those skilled in the art without departing from the gist of the present disclosure claimed in the claims. Therefore, such improvements and modifications fall within the protection scope of the present disclosure as long as they are obvious to those skilled in the art.

What is claimed is:

1. A motor cooling system comprising:
a cylindrical stator core with a coil wound to be fitted on an inner side thereof;
a housing fitted on an outer side of the stator core to support a position of the stator core, and having an injection port formed therethrough to inject a cooling fluid; and
a cooling fluid spraying part including a structure guiding the cooling fluid injected through the injection port and flowing between the stator core and the housing to flow toward the coil.

2. The motor cooling system of claim 1, wherein the stator core includes at least one first cooling passage that is a groove formed in an outer surface of the stator core in an axial direction, and
the housing includes at least one second cooling passage that is a groove formed in an inner surface of the housing in a circumferential direction.

3. The motor cooling system of claim 2, wherein the stator core includes two or more cooling lines, each including two or more first cooling passages formed adjacent to one another, and
the cooling lines are disposed to be spaced apart from one another at predetermined intervals in the circumferential direction.

4. The motor cooling system of claim 2, wherein the cooling fluid spraying part includes a nozzle ring coupled to one end of the housing, and
the nozzle ring includes:
a fixing portion coupled to one end of the inner surface of the housing;
a fluid storage portion having one end integrally formed with the fixing portion and another end in contact with one end surface of the stator core; and
a first fluid spraying hole formed through the fluid storage portion.

5. The motor cooling system of claim 2, wherein the cooling fluid spraying part includes a core support end formed at one end of the housing, and
the core support end includes:
a first support end extending from the inner surface of the housing in a radial direction;
a second support end extending from a distal end of the first support end in the axial direction; and
a second fluid spraying hole formed through at least one of the first support end or the second support end.

6. The motor cooling system of claim 1, further comprising a terminal bus bar including a first coupling portion coupled to the housing and a second coupling portion coupled to the coil,
wherein the cooling fluid spraying part further includes an extending support portion fitted between the stator core and the housing while covering an outer surface of the stator core, the extending support portion having one end coupled to the first coupling portion and the second coupling portion of the terminal bus bar.

7. The motor cooling system of claim 6, wherein the extending support portion includes:
a cylindrical first extension extending to cover the outer surface of the stator core; and
a second extension disposed between the first extension and the first and second coupling portions to cover and protect an area where the coil is provided, and
the second extension is formed to be concave inwardly from the first extension.

8. The motor cooling system of claim 7, wherein an inner surface of the first extension contacting the stator core includes a curved surface to match the outer surface of the stator core, and
an outer surface of the first extension contacting the housing is formed to be gradually inclined to the stator core toward a distal end of the first extension.

9. The motor cooling system of claim 8, wherein the housing further includes a fixing groove formed in an inner surface of the housing to correspond to the inclined outer surface of the first extension.

10. The motor cooling system of claim 7, wherein the stator core further includes a support groove formed to be concave from the outer surface of the stator core and extending in a circumferential direction, and
the first extension includes a protrusion protruding from an inner surface thereof to correspond to the support groove.
